(19) United States
(12) Patent Application Publication
(10) Pub. No.: US 2024/0266574 A1
(43) Pub. Date: Aug. 8, 2024

(54) ELECTROLYTE FORMULATION

(71) Applicant: V-FLOW TECH PTE. LTD., Singapore (SG)

(72) Inventors: Duy Tam Nguyen, Singapore (SG); Nyunt Wai Maung, Singapore (SG); Arjun Bhattarai, Singapore (SG)

(73) Assignee: V-FLOW TECH PTE. LTD., Singapore (SG)

(21) Appl. No.: 18/560,999

(22) PCT Filed: Jun. 16, 2022
(86) PCT No.: PCT/SG2022/050416

§ 371 Date: Nov. 15, 2023

(30) Foreign Application Priority Data
Jun. 17, 2021 (SG) 10202106540Q

(51) Int. Cl. H01M 8/18

(52) U.S. Cl. CPC H01M 8/188; H01M 2300/0011

(57) ABSTRACT

Provided herein is an electrolyte for a battery, the electrolyte comprising: a solvent comprising water and sulfuric acid; a vanadium salt; a deprotonation inhibitor for [VO₂(H₂O)₃]⁺; and a V₂O₅ precipitation inhibitor. Provided also are batteries comprising the electrolyte, kits comprising components of the electrolyte, a method for stabilising vanadium salts in an electrolyte by adding a deprotonation inhibitor for [VO₂(H₂O)₃]⁺; and a V₂O₅ precipitation inhibitor.

### FIELD OF THE INVENTION

The invention relates to electrolytes suitable for use in a battery, to batteries comprising the electrolytes, to kits comprising components of the electrolytes, to methods of stabilizing vanadium electrolytes and to the use of batteries of the invention for energy storage.

### BACKGROUND OF THE INVENTION

The intermit production of energy by renewable technologies requires reliable and effective energy storage systems to be suitable for wide scale grid use. Vanadium Redox Flow Batteries (VRFBs) are promising candidates for future large-scale energy storage. They are particularly suitable for autonomous energy supply systems in areas with no individual power supply, e.g. remote farms or mobile radio antennas, as well as for the storage of energy generated by photovoltaic systems or wind power plants. The unique feature of flow batteries lies in their ability to independently scale the energy storage capacity and the power output of the system, thus rendering this technology very versatile with respect to the local circumstances of the energy source.

The electrolyte used in VRFB comprises vanadium salts dissolved in sulfuric acid. However, the V(V) species has a relatively low solubility in sulfuric acid and tends to form a solid precipitate at high temperatures. This process starts by the deprotonation of the hydrate penta-coordinated [VO₂(H₂O)₃]⁺ cation, which is the typical structure of V(V) in sulfuric acid. With increasing temperatures, the precipitation occurs faster, forming bigger precipitate particles and damaging the system. The precipitation process includes two main steps, deprotonation and condensation reactions:

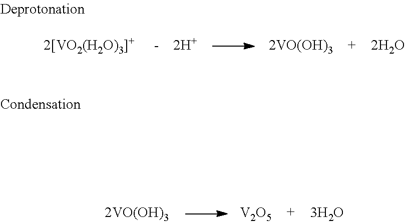

Based on this mechanism, many inorganic and organic additives have been studied to prevent the precipitation, and thus improving the thermal stability of vanadium electrolyte. The first priority to restrict the precipitation is inhibiting the deprotonation of the hydrate penta-coordinated [VO₂(H₂O)₃]⁺ structure. This could be achieved by adding the additive that can form the soluble neutral species with hydrate penta-coordinated V(V) ion.

Another approach is to focus on inhibiting the condensation of V₂O₅. It has been reported that some organic compounds can adsorb via polarized functional groups, such as OH, CHO, C═O, on the initial V₂O₅ nuclei, hindering further growth and formation of particles large enough to precipitate. These reported organic compounds include methanesulfonic acid, trifluoroacetic acid, polyacrylic acid, oxalic acid, and methacrylic acid [1]; L-glutamate [2]; coulter dispersant IIIA [3]; trishydroxymethylaminomethane (Tris) [4]; fructose, mannitol, glucose, and D-sorbitol [5]; inositol, phytic acid and sodium oxalate [6,7].
[1] G. Wang, et al. Study on stabilities and electrochemical behaviour of V(V) electrolyte with acid additives for vanadium redox flow battery. J. Energy Chemistry 23 (2014) 73-81.
[2] Y. Lei, et al. Effect of Amino Acid Additives on the Positive Electrolyte of Vanadium Redox Flow Batteries. J. Electrochem. Soc. 160 (4) (2013) A722-A727.
[3] F. Chang, et al. Coulter dispersant as positive electrolyte additive for the vanadium redox flow battery. Electrochimica Acta 60 (2012) 334-338.
[4] S. Peng, N et al. Influence of Trishydroxymethyl Aminomethane as a Positive Electrolyte Additive on Performance of Vanadium Redox Flow Battery. Int. J. Electrochem. Sci. 7 (2012) 2440-2447.
[5] S. U, et al. Effect of organic additives on positive electrolyte for vanadium redox battery. Electrochimica Acta 56 (2011) 5483-5487.
[6] X. Wu, et al. Influence of organic additives on electrochemical properties of the positive electrolyte for all-vanadium redox flow battery. Electrochimica Acta 78 (2012) 475-482.
[7] D. Kim, J. Jeon. An electrolyte with high thermal stability for the vanadium redox flow battery. Advanced Materials, Mechanical and Structure Engineering, 2016, Taylor & Francis Group, London, ISBN: 978-1-138-02908-8.

These polar additives were claimed to help maintain the operation of the system, and the small nuclei of V₂O₅ can be dissolved back to the electrolyte solution during discharging process.

To date, the most effective additive has been reported for positive vanadium electrolyte is hydrochloric acid, which can stabilize the positive electrolyte at high state of charge and high temperature (US 2012/0077079). However, using hydrochloric acid as a thermal stabilizing agent has a number of major disadvantages:
i) the presence of chloride anions introduces the possibility of forming toxic chlorine gas under certain failure conditions (e.g. overcharging of cells);
ii) HCl produces a very corrosive atmosphere of hydrogen chloride gas in the tank and gas lines—this can also be a problem in the event of accidental spillage; and
iii) the electrolyte is generally much more corrosive than the standard electrolyte, and therefore limits the materials of construction.

Phosphoric acid and phosphate compounds have been reported as alternatives for hydrochloric acid to stabilize the electrolyte (JP 2002216833, and J. Zhang, et al, J. Appl. Electrochem., 41 (2011) 1215-1221). Ammonium phosphate has also been used as an additive (CN 104300168). However, these additives are normally not so effective when used at high concentration and can lead to the formation of other solid precipitates such as VOₓPO₄ in the electrolyte. Further additives have also been suggested, though many were not tested and can in fact be shown to be completely ineffective in practice (AU 704534, WO 95/12219).

There have been few reports of the use of organic compounds to stabilize the electrolyte. In some cases it is clear that such organic additives can be oxidized by V(V) in the positive electrolyte, thereby reducing the state-of-charge (T. D. Nguyen, et al., Journal of Power Sources, 2016, 334, 94-103). At lower state-of-charge the positive electrolyte is more thermally stable, but the usable capacity of the battery is reduced, and therefore this approach is not advantageous. It is also likely that many organic compounds would foul the ion exchange membranes or coat on the electrodes, causing the internal resistance of the battery to rise.

### BRIEF DESCRIPTION OF THE INVENTION

The inventors have surprisingly found that the use of two separate additives inhibiting each of the precipitation steps provides a substantially more effective thermal stabilization of the positively charged vanadium electrolyte. The two separate additives are a first additive that is a deprotonation inhibitor for [VO₂(H₂O)₃]⁺ and a second additive that is a V₂O₅ precipitation inhibitor.

The reactions involved in the degradation of [VO₂(H₂O)₃]⁺ are shown in FIGS. 1 and 2. FIG. 2 indicates the reactions inhibited by the deprotonation inhibitor for [VO₂(H₂O)₃]⁺ (201) and the V₂O₅ precipitation inhibitor (202).

Thus, the invention provides an electrolyte for a battery, the electrolyte comprising:
a solvent comprising water and sulfuric acid;
a vanadium salt;
a deprotonation inhibitor for [VO₂(H₂O)₃]⁺; and
a V₂O₅ precipitation inhibitor.

A deprotonation inhibitor for [VO₂(H₂O)₃]⁺ may hinder the initial condensation of V(V) by complexing with the VO₂⁺ ion, while the V₂O₅ precipitation inhibitor may block the surface of initial V₂O₅ nuclei, hindering further growth and formation of particles large enough to precipitate. This type of additive is generally not oxidized by V(V) and is therefore stable in positive electrolyte.

Based on the inventor's surprising findings, the invention provides the following numbered statements.
1. An electrolyte for a battery, the electrolyte comprising:
   a solvent comprising water and sulfuric acid;
   a vanadium salt;
   a deprotonation inhibitor for [VO₂(H₂O)₃]⁺; and
   a V₂O₅ precipitation inhibitor.
2. An electrolyte for a battery according to Statement 1, wherein:
   the deprotonation inhibitor for [VO₂(H₂O)₃]⁺ is an inorganic compound.
3. An electrolyte for a battery according to Statement 2, wherein the inorganic compound is present in an amount of from 0.001 to 3 wt % of the combined weight of the vanadium salt and the solvent
4. An electrolyte for a battery according to Statement 3, wherein the inorganic compound is present in an amount of from 0.25 to 1 wt % of the combined weight of the vanadium salt and the solvent
5. An electrolyte for a battery according to any one of Statements 2 to 4 wherein the inorganic compound is selected from one or more of the group consisting of a phosphate salt and a non-halide ammonium containing compound.
6. An electrolyte for a battery according to Statement 5, wherein the inorganic compound is selected from one or more of the group consisting of a sodium phosphate, a potassium phosphate and an ammonium phosphate.
7. An electrolyte for a battery according to Statement 6, wherein the inorganic compound is one or both of NH₄H₂PO₄ and (NH₄)₂HPO₄.
8. An electrolyte for a battery according to any one of the preceding Statements, wherein the V₂O₅ precipitation inhibitor is an organic compound.
9. An electrolyte for a battery according any Statement 8, wherein the organic compound is present in an amount of from 0.0001 to 0.5 wt % of the combined weight of the vanadium salt and the solvent.
10. An electrolyte for a battery according to Statement 9, wherein the organic compound is present in an amount from 0.025 to 0.1 wt % of the combined weight of the vanadium salt and the solvent
11. An electrolyte for a battery according to any one of Statements 8 to 10, wherein the organic compound is selected from one or more of the group consisting of a water-soluble polymer and a water-soluble gelatin compound.
12. An electrolyte for a battery according to Statement 11, wherein the organic compound is selected from one or more of the group consisting of polyvinylpyrrolidone (PVP), and a water-soluble polyalkylene glycol,
   optionally wherein the organic compound is selected from one or more of polyvinylpyrrolidone and polyethylene glycol.
13. An electrolyte for a battery according to any one of the preceding Statements, wherein the inorganic compound includes NH₄H₂PO₄ and the organic compound includes PVP.
14. An electrolyte for a battery according to any one of Statements 2 to 12, wherein the inorganic compound includes (NH₄)₂HPO₄ and the organic compound includes PVP.
15. An electrolyte for a battery according to any one of the preceding Statements, wherein the vanadium salt comprises a vanadium sulfate.
16. An electrolyte for a battery according to any one of the preceding Statements, wherein the electrolyte comprises vanadium ions in a concentration of from 1.0 to 3.0 M.
17. An electrolyte for a battery according to Statement 16, wherein the electrolyte comprises vanadium ions in a concentration of from 1.6 to 2M.
18. An electrolyte for a battery according to any one of the preceding Statements, wherein the electrolyte comprises sulphate ions in a concentration of from 2 to 6M.
19. An electrolyte for a battery according to Statement 18, wherein the electrolyte comprises sulphate ions in a concentration of from 4 to 5M.
20. An electrolyte for a battery, the electrolyte comprising:
   water,
   vanadium ions present in a concentration from 1.6 M to 2M;
   sulfate ions present in a concentration of from 4 M to 5M; and
   at least two additives, wherein
   the at least two additives prevent the precipitation of more than 150 mg of V₂O₅ per 2
   mL of the electrolyte following heating of the electrolyte for 7 days at 50° C.
21. An electrolyte for a battery according to Statement 20, wherein the at least two additives include:
   ammonium phosphate present in an amount of from 0.25 to 1 wt % of the weight of the electrolyte without the additives; and
   PVP present in an amount of from 0.025 to 0.1 wt % of the weight of the electrolyte without the additives.
22. A redox flow battery comprising the electrolyte of any one of Statements 1 to 21.
23. A kit of parts for stabilizing a vanadium electrolyte for use in a vanadium redox flow battery, the kit of parts comprising:
   (a) a first additive composition comprising a deprotonation inhibitor for [VO₂(H₂O)₃]⁺; and
   (b) a second additive composition comprising a V₂O₅ precipitation inhibitor.
24. A kit of parts for stabilizing a vanadium electrolyte for use in a vanadium redox flow battery according to Statement 23, wherein the deprotonation inhibitor for [VO₂(H₂O)₃]⁺ comprises an inorganic compound.
25. A kit of parts for stabilizing a vanadium electrolyte for use in a vanadium redox flow battery according to Statement 24, wherein the inorganic compound is selected from one or more of the group consisting of a phosphate salt and a non-halide ammonium containing compound.
26. A kit of parts for stabilizing a vanadium electrolyte for use in a vanadium redox flow battery according to Statement 25, wherein the inorganic compound is selected from one or more of the group consisting of a sodium phosphate, a potassium phosphate and an ammonium phosphate.
27. A kit of parts for stabilizing a vanadium electrolyte for use in a vanadium redox flow battery according to Statement 26, wherein the inorganic compound is one or both of NH₄H₂PO₄ and (NH₄)₂HPO₄.
28. A kit of parts for stabilizing a vanadium electrolyte for use in a vanadium redox flow battery according to any one of Statements 23 to 27, wherein the V₂O₅ precipitation inhibitor comprises an organic composition.
29. A kit of parts for stabilizing a vanadium electrolyte for use in a vanadium redox flow battery according to Statement 28, wherein the organic composition comprises an aqueous solution of an organic compound selected from one or more of the group consisting of a water-soluble polymer and a water-soluble gelatin.
30. A kit of parts for a stabilizing additive for addition to an electrolyte for a vanadium redox flow battery according to Statement 29, wherein the organic compound is selected from one or more of the group consisting of polyvinylpyrrolidone (PVP), and a water-soluble polyalkylene glycol,
   optionally wherein the organic compound is selected from one or more of polyvinylpyrrolidone and polyethylene glycol.
31. A kit of parts for a stabilizing additive for addition to an electrolyte for a vanadium redox flow battery according to Statement 29 or 30, wherein the organic compound is present in a concentration of greater than or equal to 50 mg/mL in the aqueous solution.
32. A method of stabilizing a vanadium electrolyte for use in a vanadium redox flow battery, the vanadium electrolyte comprising:
   a solvent comprising water and sulfuric acid, and
   a vanadium salt, the method comprising obtaining a stabilized electrolyte by:
   adding a deprotonation inhibitor for [VO₂(H₂O)₃]⁺ and a V₂O₅ precipitation inhibitor to the vanadium electrolyte.
33. A method of stabilizing a vanadium electrolyte for use in a vanadium redox flow battery according to Statement 32, wherein the deprotonation inhibitor for [VO₂(H₂O)₃]⁺ is an inorganic compound
34. A method of stabilizing a vanadium electrolyte for use in a vanadium redox flow battery according to Statement 33, wherein adding the deprotonation inhibitor for [VO₂(H₂O)₃]⁺ comprises dissolving the inorganic compound in the solvent
35. A method of stabilizing a vanadium electrolyte for use in a vanadium redox flow battery according to Statement 34, wherein the inorganic compound is present in an amount of 0.001-3 wt % of the vanadium electrolyte.
36. A method of stabilizing a vanadium electrolyte for use in a vanadium redox flow battery according to Statement 35, wherein the inorganic compound is present in an amount of 0.25-1 wt % of the stabilized electrolyte.
37. A method of stabilizing a vanadium electrolyte for use in a vanadium redox flow battery according to any one of Statements 32 to 36, wherein the inorganic compound is selected from one or more of the group consisting of a sodium phosphate, a potassium phosphate and an ammonium phosphate.
38. A method of stabilizing a vanadium electrolyte for use in a vanadium redox flow battery according to Statement 37, wherein the inorganic compound is one or both of NH₄H₂PO₄ and (NH₄)₂HPO₄.
39. A method of stabilizing a vanadium electrolyte for use in a vanadium redox flow battery according to any one of Statements 32 to 38, wherein the V₂O₅ precipitation inhibitor is an organic compound.
40. A method of stabilizing a vanadium electrolyte for use in a vanadium redox flow battery according to Statement 39, wherein adding the V₂O₅ precipitation inhibitor comprises dissolving the organic compound in water to obtain an aqueous solution of the organic compound and adding the aqueous solution of the organic compound to the vanadium electrolyte.
41. A method of stabilizing a vanadium electrolyte for use in a vanadium redox flow battery according to Statement 40, wherein the organic compound is selected from one or more of the group consisting of a water-soluble polymer and a water-soluble gelatin
42. A method of stabilizing a vanadium electrolyte for use in a vanadium redox flow battery according to Statement 41, wherein the organic compound is selected from one or more of the group consisting of polyvinylpyrrolidone (PVP), and a water-soluble polyalkylene glycol,
   optionally wherein the organic compound is selected from one or more of polyvinylpyrrolidone and polyethylene glycol.
43. The use of a redox flow battery according to Statement 22 for energy storage.

As used herein, the combination of the deprotonation inhibitor for [VO₂(H₂O)₃]⁺ and a V₂O₅ precipitation inhibitor may be referred to as a combined additive.

### BRIEF DESCRIPTION OF THE FIGURES

FIG. 1: Precipitation process of the positive vanadium electrolyte at high temperatures and long heating time.

FIG. 2: Description of thermal stabilizing mechanism of combined additive.

FIG. 3: Structure of a VRFB single cell for testing the performance of the electrolyte.

FIG. 4: Precipitation time for vanadium electrolytes containing stabilizing additives at 45 and 50° C. The precipitation time for the combined additives (deprotonation and precipitation inhibitors) is shown against the PVP concentration. The square symbols represent the data for blank electrolyte containing PVP (a V₂O₅ precipitation inhibitor) but no deprotonation inhibitor for [VO₂(H₂O)₃]⁺, while the data points at 0 wt % PVP denote the blank electrolyte containing the deprotonation inhibitor only.

FIG. 5: Degree of precipitation for vanadium electrolytes with different stabilizing additives after varying heating times at 50° C.

FIG. 6: Precipitate particle size distribution of vanadium electrolyte containing different thermal stable additives (1.6 M V in 4 M total SO₄²⁻). Sample: 2 mL, 90% SOC, heated at 50° C. for 5 days.

FIG. 7: XRD patterns of different vanadium precipitates obtained by heating electrolyte solution with and without additives at 50° C. in 10 days. Sample: 5 mL. Precipitate: filtrated in 24 h, dried at 60° C. in air for 24 h.

FIG. 8: Chemical stability of combined additives in strong oxidative condition of positive vanadium electrolyte. UV-vis spectra of 1.6 M V(V) in 4 M H₂SO₄ solution with the addition of thermal stable combined inorganic-organic additives. The UV-vis spectra of V(IV) and V(V) solutions are also displayed for comparison.

FIG. 9: Cyclic voltammograms at 10 mV s⁻¹ sweep rate (a) and Nyquist plot (b) of the positive vanadium electrolyte with the addition of different thermal stable additives at room temperature. All electrochemical measurements were performed at room temperature using 90% SOC electrolyte.

FIG. 10: The voltage efficiency (a, d), capacity drop (b, e), and cell resistivity (c, f) of cell cycling with different electrolyte compositions at 25 (a-c) and 50° C. (d-f). Cell: 20 cm² active area; electrolyte volume: 100 mL; flow-rate: 50 mL/min; current density: 100 mA/cm²; potential window: 0.9-1.65 V; oxidation prevention layer: Paraffin oil (10 mm); membrane: Fumatech FAP 450 AEM.

FIG. 11: The view of flow-frame (a-c) and FESEM image (d-f) of graphite felt in positive side after cycling with different vanadium electrolytes at 50° C. for over 100 cycles using the cell assembled with Fumatech FAP 450 AEM.

FIG. 12: The voltage efficiency (a), capacity drop (b), and cell resistivity (c) of cell cycling with different electrolyte compositions at 25 and 50° C. Cell: 20 cm² active area; electrolyte volume: 100 mL; flow-rate: 50 mL/min; current density: 100 mA/cm²; potential window: 0.9-1.65 V; oxidation prevention layer: Paraffin oil (10 mm); membrane: Nafion 117 CEM.

FIG. 13: The view of flow-frame (a-c) and FESEM image (d-f) of graphite felt in positive side after cycling with different vanadium electrolytes at 50° C. for over 100 cycles using the cell assembled with Nafion 117 CEM.

FIG. 14: The influence of combined additive (0.025% wt PVP+0.25% wt (NH4)2HPO4) on the electrolyte temperature (a), flow-rate (b), and pressure (c) of 3-stack cell cycling. Cell: 625 cm² active area; electrolyte volume: 1.5 L; current density: 80 mA cm⁻²; membrane: Fumatech FAP 450; bipolar plate: PV15; end plate: F100 monolithic carbon plate; number of cycle: 200. The comparison between the electrochemical performance of 3-stack VRFB system using blank and additive-added electrolytes is shown in (d)-(f).

FIG. 15: The influence of combined additive (0.025% wt PVP+0.25% wt (NH4H2PO4) on the electrolyte temperature (a), flow-rate (b), and pressure (c) of 3-stack cell cycling. Cell: 625 cm² active area; electrolyte volume: 1.5 L; current density: 80 mA cm⁻²; membrane: Fumatech FAP 450; bipolar plate: PV15; end plate: F100 monolithic carbon plate; number of cycle: 200.

FIG. 16: Performance of the combined additive compared to pristine electrolyte in a 1 kW VRFB system.

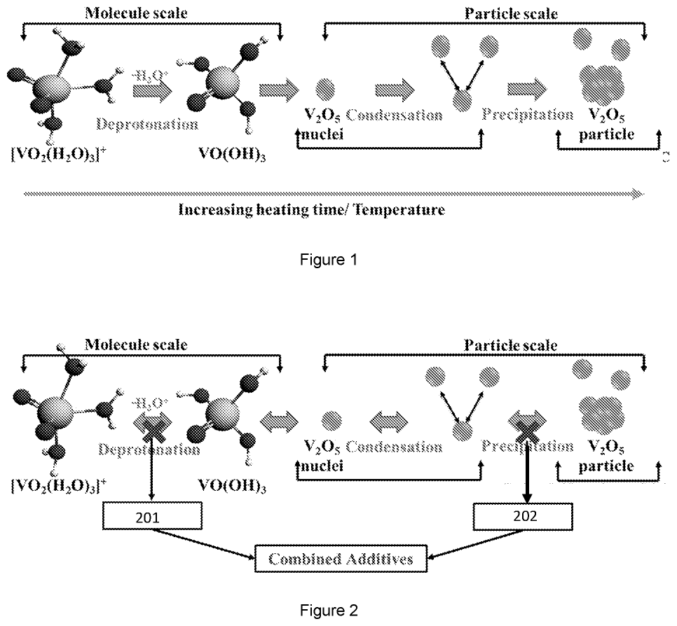

### DETAILED DESCRIPTION OF THE INVENTION

The invention provides an electrolyte for a battery, the electrolyte comprising:
a solvent comprising water and sulfuric acid;
a vanadium salt;
a deprotonation inhibitor for [VO₂(H₂O)₃]⁺; and
a V₂O₅ precipitation inhibitor.

The invention is based on the surprising finding that the use of two additives in combination—a deprotonation inhibitor for [VO₂(H₂O)₃]⁺ and a V₂O₅ precipitation inhibitor—is able to provide a thermally stable vanadium electrolyte, while avoiding health and safety risks.

The use of the two additives in combination provides a number of advantages, which are listed below.
When used together the additives provide a synergistic effect and improve the stability of the vanadium electrolyte more than the sum of the improvements provided by the additives when used alone.
The use of combined additives minimises the disadvantages associated with some common additives, allowing wider operation temperature of the VRFB.
In contrast to many organic additives containing polar functional groups, the use of two additives in combination does not change the oxidation state of vanadium ions and the state-of-charge of vanadium electrolyte (i.e. the additives are not oxidized by the positive electrolyte).
The combined additive has a relatively small influence on the redox reaction kinetics, electrolyte resistance in static condition.
The combined additive has a very small influence on the electrolyte viscosity and pressure drop of electrolyte flow in an operation VRFB system.
The combined additive has a relatively small influence on the cell performance, which did not significantly change the efficiency of VRFB cell.
The combined additives are also friendly to the environment and safe for users.
The additives may be easily incorporated into existing vanadium electrolyte solutions, to provide an electrolyte solution according to the invention.

The electrolyte of the invention comprises a deprotonation inhibitor for [VO₂(H₂O)₃]⁺. The deprotonation inhibitor for [VO₂(H₂O)₃]⁺ may in general be a compound/species that is able to complex with the V(V) species (i.e. [VO₂(H₂O)₃]⁺) to provide a stable soluble neutral species. An example of a suitable species that is able to complex with the V(V) species is a phosphate ion (e.g. one or more of [PO₄]³⁻, [HPO₄]²⁻ and [H₂PO₄]⁻; see M. J. Gresser, et al., Journal of the American Chemical Society, 1986, 108, 6229-6234; N. V. Roznyatovskaya, eta, Journal of Power Sources, 2017, 363, 234-243). Without being bound by theory, it is believed that organophosphate ions [RPO₄]²⁻ and [R₂PO₄]⁻ may also form the same complexes with the V(V) species. Thus, any species that is able to produce one of these ions in the solvent of the electrolyte (i.e. a solvent comprising water and sulfuric acid) may act as a deprotonation inhibitor for [VO₂(H₂O)₃]⁺. Without being bound by theory, it is believed that high concentrations of phosphoric acid may result in precipitation of vanadium phosphate species. Therefore, in some embodiments of the invention that may be mentioned herein, the deprotonation inhibitor for [VO₂(H₂O)₃]⁺ may comprise an anion selected from [HPO₄]²⁻ and [H₂PO₄]⁻.

For the avoidance of doubt, the term “phosphate” as used herein may refer to any of the following ions: [PO₄]³⁻, [HPO₄]²⁻, [H₂PO₄]⁻, [RPO₄]²⁻ and [R₂PO₄]⁻, where R is an organic group, such as a C₁₋₁₀ (e.g. C₁₋₆) organic group (e.g. an aliphatic group such as alkyl). In some embodiments of the invention that may be mentioned herein, the phosphate may be selected from the group consisting of [PO₄]³⁻, [HPO₄]²⁻, and [H₂PO₄]⁻.

A skilled person will understand that when in aqueous solution the ions [PO₄]³⁻, [HPO₄]⁻, and [H₂PO₄]⁻ may exist in a pH-dependent equilibrium with the fully protonated form, H₃PO₄. A skilled person will understand that in the sulfuric acid/water electrolyte used in the battery of the invention, the main phosphate ions present will be the partially protonated forms, e.g. [HPO₄]²⁻ and [H₂PO₄]⁻, particularly [H₂PO₄]⁻. Corresponding logic may be applied to organic phosphate ions, which may predominantly exist as [R₂PO₄]⁻ and [RHPO₄]⁻.

In some embodiments of the invention that may be mentioned herein, the deprotonation inhibitor for [VO₂(H₂O)₃]⁺ may be present in an equimolar amount to the V(V) species. For example, the deprotonation inhibitor for [VO₂(H₂O)₃]⁺ may result in a molar concentration of phosphate that is at least as high as the concentration of [VO₂(H₂O)₃]⁺ in solution. For example, the deprotonation inhibitor for [VO₂(H₂O)₃]⁺ may be able to provide phosphate ([PO₄]³⁻) ions in an amount of at least 0.034 mM (3.26 mg/L of [PO₄]³⁻) in 4 M H₂SO₄. This corresponds to 0.001 wt. % of 2 M VOSO₄ in 4 M H₂SO₄, which is an effective vanadium electrolyte (F. Rahman, et al., J. Power Sources 1998, 72, 105).

The deprotonation inhibitor for [VO₂(H₂O)₃]⁺ may comprise any suitable counterion. A particular example of a counterion that may be present is ammonium, NH₄⁺. However, other counterions, such as substituted ammonium ions (whether primary, secondary, tertiary or quaternary), may also be used, provided they are soluble in the electrolyte.

It is desirable that the deprotonation inhibitor for [VO₂(H₂O)₃]⁺ does not include halide ions, because halide ions cause a number of disadvantages in vanadium batteries.

The electrolyte comprises a V₂O₅ precipitation inhibitor. As explained above, deprotonation of [VO₂(H₂O)₃]⁺ results in VO(OH)₃, which condenses in solution to provide V₂O₅, which accumulates and precipitates to form particles that grow over time and eventually damage the system. Species that are able to interact with dissolved V₂O₅ to prevent accumulation and precipitate formation are therefore useful in the electrolyte. In general, soluble polymers that are able to coat/surround nuclei of V₂O₅ in solution will prevent the accumulation of sufficient amounts of V₂O₅ for precipitation. The polymers must be soluble in the aqueous sulfuric acid solvent used in the battery, and also should not comprise repeating units having functional groups that are susceptible to oxidation by the V(V), such as OH and COOH (T. D. Nguyen, et al., Journal of Power Sources, 2016, 334, 94-103). A skilled person would easily be able to identify such groups that are susceptible to oxidation from basic knowledge of organic chemistry.

In some embodiments of the invention that may be mentioned herein, the V₂O₅ precipitation inhibitor is at least as soluble as V₂O₅. For example, the V₂O₅ precipitation inhibitor may have a solubility at least 0.326 mg/L in 4 M H₂SO₄ (corresponding to 0.0001 wt. % of 2 M VOSO₄ in 4 M H₂SO₄).

Particular aspects and embodiments of the invention are discussed below.

In some embodiments of the invention that may be mentioned herein, the deprotonation inhibitor for [VO₂(H₂O)₃]⁺ may comprise an inorganic compound.

In some embodiments of the invention that may be mentioned herein, the deprotonation inhibitor for [VO₂(H₂O)₃]⁺ may be present at an amount of from 0.001 to 3 wt % of the combined weight of the vanadium salt and the solvent, for example from 0.25 to 1 wt %.

In some embodiments of the invention that may be mentioned herein, the inorganic compound may be selected from one or more of the group consisting of a phosphate salt and a non-halide ammonium containing compound. For example, the inorganic compound may be selected from one or more of the group consisting of a sodium phosphate, a potassium phosphate and an ammonium phosphate. Specific inorganic compounds that may be mentioned herein include one or both of NH₄H₂PO₄ and (NH₄)₂HPO₄.

In some embodiments of the invention that may be mentioned herein, the V₂O₅ precipitation inhibitor may comprise an organic compound.

In some embodiments of the invention that may be mentioned herein, the V₂O₅ precipitation inhibitor may be present in an amount of from 0.0001 to 0.5 wt % of the combined weight of the vanadium salt and the solvent, for example from 0.025 to 0.1 wt %.

In some embodiments of the invention that may be mentioned herein, the organic compound may be selected from one or more of the group consisting of a water-soluble polymer and a water-soluble gelatin compound.

In some embodiments of the invention that may be mentioned herein, the organic compound may be selected from one or more of the group consisting of polyvinyl alcohol (PVA), polyvinylpyrrolidone (PVP), polyacrylic acid (PAA) and polyacrylate. In alternative embodiments of the invention, the organic compound may be selected from one or more of the group consisting of polyvinylpyrrolidone (PVP) and a water-soluble polyalkylene glycol. For example, the organic compound may be selected from one or both of polyvinylpyrrolidone and polyethylene glycol. In some embodiments of the invention that may be mentioned herein, the organic compound may be polyvinylpyrrolidone.

In some embodiments of the invention that may be mentioned herein, the V₂O₅ precipitation inhibitor may be a water-soluble polymer (e.g. PVP or polyethylene glycol) having an average molecular weight (e.g. a weight average molecular weight) of at least 10,000, such as 10,000 to 100,000, or 10,000 to 50,000.

Specific combinations of organic compound and inorganic compound that may be mentioned herein include the combinations where the inorganic compound includes NH₄H₂PO₄ and the organic compound includes PVP, and where the inorganic compound includes (NH₄)₂HPO₄ and the organic compound includes PVP.

In some embodiments of the invention that may be mentioned herein, the vanadium salt may comprise a vanadium sulfate.

In some embodiments of the invention that may be mentioned herein, the electrolyte may comprise vanadium ions in a concentration of from 1.0 to 3.0 M, for example from 1.6M to 2M.

In some embodiments of the invention that may be mentioned herein, the electrolyte may comprise sulphate ions in a concentration of from 2M to 6M, for example from 4M to 5M.

In some embodiments of the invention that may be mentioned herein, the invention provides an electrolyte for a battery, the electrolyte comprising:
water,
vanadium ions present in a concentration from 1.6 M to 2M;
sulfate ions present in a concentration of from 4 M to 5M; and
at least two additives, wherein
   the at least two additives prevent the precipitation of more than 150 mg of V₂O₅ per 2 mL of the electrolyte following heating of the electrolyte for 7 days at 50° C.

In some aspects of this embodiment, the at least two additives include:
ammonium phosphate present in an amount of from 0.25 to 1 wt % of the weight of the electrolyte without the additives; and
PVP present in an amount of from 0.025 to 0.1 wt % of the weight of the electrolyte without the additives.

The invention provides a redox flow battery comprising the electrolyte of the invention. The redox flow battery according to the invention may be useful in energy storage, and the invention therefore also provides the use of a redox flow battery according to the invention for energy storage.

The invention also provides a kit of parts for stabilizing a vanadium electrolyte for use in a vanadium redox flow battery, the kit of parts comprising:
(a) a first additive composition comprising a deprotonation inhibitor for [VO₂(H₂O)₃]⁺; and
(b) a second additive composition comprising a V₂O₅ precipitation inhibitor.

In the kit of parts according to the invention, the deprotonation inhibitor for [VO₂(H₂O)₃]⁺, and the V₂O₅ precipitation inhibitor may be as defined hereinabove in relation to the electrolyte of the invention.

In the kit of parts according to the invention, the V₂O₅ precipitation inhibitor may comprise an organic composition. For example, the V₂O₅ precipitation inhibitor may comprise an aqueous solution of an organic compound, such as an aqueous solution of an organic compound selected from one or more of the group consisting of a water-soluble polymer and a water-soluble gelatin. In these cases, the organic compound may be present in a concentration of greater than or equal to 50 mg/mL in the aqueous solution.

The invention also provides a method of stabilizing a vanadium electrolyte for use in a vanadium redox flow battery, the vanadium electrolyte comprising:
a solvent comprising water and sulfuric acid, and
a vanadium salt,
   the method comprising obtaining a stabilized electrolyte by:
adding a deprotonation inhibitor for [VO₂(H₂O)₃]⁺ and a V₂O₅ precipitation inhibitor to the vanadium electrolyte.

In the method of stabilizing a vanadium electrolyte for use in a vanadium redox flow battery according to the invention, the deprotonation inhibitor for [VO₂(H₂O)₃]⁺, V₂O₅ precipitation inhibitor and vanadium salt may be as defined hereinabove in relation to the electrolyte of the invention or the kit of parts according to the invention.

In some embodiments of the method of the invention, adding the deprotonation inhibitor for [VO₂(H₂O)₃]⁺ comprises dissolving the deprotonation inhibitor for [VO₂(H₂O)₃]⁺ (e.g. an inorganic compound) in the solvent.

In some embodiments of the method of the invention, the deprotonation inhibitor for [VO₂(H₂O)₃]⁺ (e.g. an inorganic compound) is present in an amount of 0.001 to 3 wt % of the stabilized electrolyte, such as 0.25 to 1 wt %.

In some embodiments of the method of the invention, adding the V₂O₅ precipitation inhibitor may comprise dissolving the V₂O₅ precipitation inhibitor (e.g. an organic compound) in water to obtain an aqueous solution of the V₂O₅ precipitation inhibitor (e.g. organic compound) and adding the aqueous solution of the V₂O₅ precipitation inhibitor (e.g. organic compound) to the vanadium electrolyte.

The invention is illustrated by the below Examples, which are not to be construed as limitative.

### EXAMPLES

For the avoidance of doubt, the deprotonation inhibitor for [VO₂(H₂O)₃]⁺ and the V₂O₅ precipitation inhibitor may be referred to below, whether alone or in combination, as “additives”, e.g. as mono additives or dual additives.

For brevity and ease of reference herein, specific combinations of additive are assigned indicators as shown below.

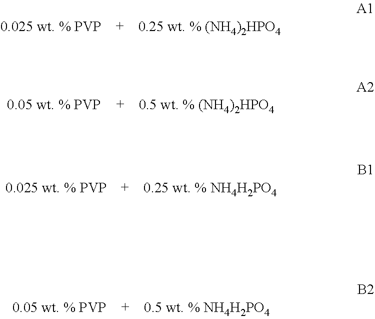

### Materials

Vanadium electrolyte (1.6 M VIII/IV) in 4 M total SO₄²⁻) were purchased from AMG Titanium Alloys & Coatings, Germany and used as-received.

The additives were purchased and used as-received: ammonium dihydrogen phosphate (Sigma-Aldrich, ≥99.99% trace metals basis), ammonium hydrogen phosphate (Sigma-Aldrich, ≥99.99% trace metals basis), ammonium phosphate (Reagent, Astral Scientific).

Graphite felt (GFD 4.6 EA, SGL Carbon Group) was exploited as porous electrode. To improve the cell efficiency, the felt was thermo-activated by heating at 600° C. for 5 h). The bipolar plate is expended graphite (TF 6/PV 15, 0.6 mm, SGL Carbon Group) for 20 cm² active cell, and monolithic carbon plate (F100, 2 mm, SGL USA) for 3-stack cell.

The separator was anion exchange membrane (AEM, Fumatech FAP 450, 50 μm thickness) and cation exchange membrane (CEM, Nafion 117, 177.8 μm thickness).

Moreover, the cell also used PVC flow frame and copper plate as current collector.

### General Methods

### Positive Electrolyte Preparation

The positive electrolyte was prepared at room temperature (22-25° C.) by a single cell with 20 cm² active area. The main component of the cell includes PVC flow frame, expended graphite bipolar plate (TF 6, SGL Carbon Group), graphite felt porous electrode (GFD 4.6 EA, SGL Carbon Group, heat treated at 600° C. for 5 h), and anion type exchange membrane (FAP 450, Fumatech). The constant applied current is of 40 mA·cm⁻² controlled by a NEWARE battery tester. The pristine vanadium electrolyte was pumped through the cell by a peristaltic pump with flow-rate of 10 mL/min. The stage of charge (SOC) of positive electrolyte was estimated based on the relation of the open circuit voltage (OCV) and SOC was calculated by Nernst equation. In this work, we employed the vanadium positive electrolyte with the 90% SOC for the thermal stability test. For ultraviolet-visible (UV-Vis) spectroscopic measurement, the 0% and 100% SOC electrolyte solution (V(V)) was prepared.

### Cell Composition

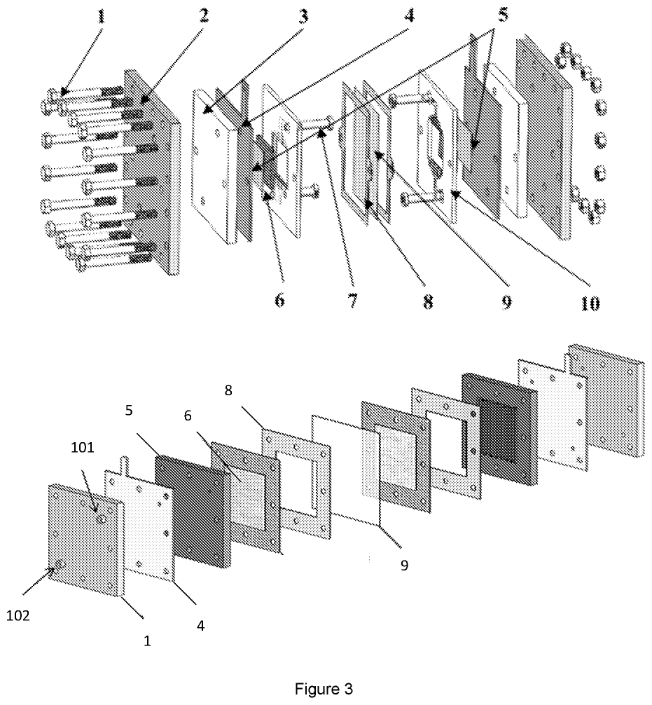

The components used to form a VRFB single cell are shown in FIG. 3.
101—Inlet
102—Outlet
1—Bolt and nut: connect the cell components.
2—End plates: made by thick stainless steel to uniformly distribute compressive stress on the cell.
3—Insulating polypropylene plate: prevent shorting of the cell.
4—Current collecting plates: copper plate acts as the current collecting plate and a connection to the external circuitry.
5—Graphite bipolar plate: acts as the current collector for the electrode, as direct exposure of the copper to the porous graphite felt electrode will result in rapid corrosion of the copper plate as it will be exposed to the highly acidic electrolyte.
6—Graphite felt electrode: acts as the main reaction site for the cell, through which the electrolyte is pumped.
7—Polypropylene electrolyte pipe connects the flow frame to the electrolyte pipe.
8—Gasket: an incompressible poly-tetrafluoroethylene gasket serves as a seal between the flow frame and the membrane.
9—Ion exchange membrane.
10—Flow frame is designed so as to allow an even distribution of the electrolyte flow to minimize dead regions.

The electrolyte temperature was controlled by two magnetic hotplates (Heidolph, 505-30080 00 MR Silver Package-Magnetic Stirrer MR Hei-Tec, Temp. Sensor PT 1000 (V4A), Clamp). The additives were dissolved into the pristine vanadium electrolyte at room temperature prior to the cycling test.

### Example 1: Thermal Stability Test

### Methods

The thermal stability test was conducted using a straightforward apparatus including a water-bath and a thermometer to control the temperature. 5 mL aliquots of positive vanadium electrolyte (90% SOC) were used for testing, with the addition of the given additives. All electrolyte samples were heated and kept at different constant temperatures (45, 50° C.). The samples were checked hourly to detect the precipitate by a physical method (see below the tested tube) when sufficiently large amounts had formed, and the time to onset of precipitation was noted. In order to gain accurate information regarding the onset time, the thermal stability test was repeated at least 3 times for each additive compound.

### Results

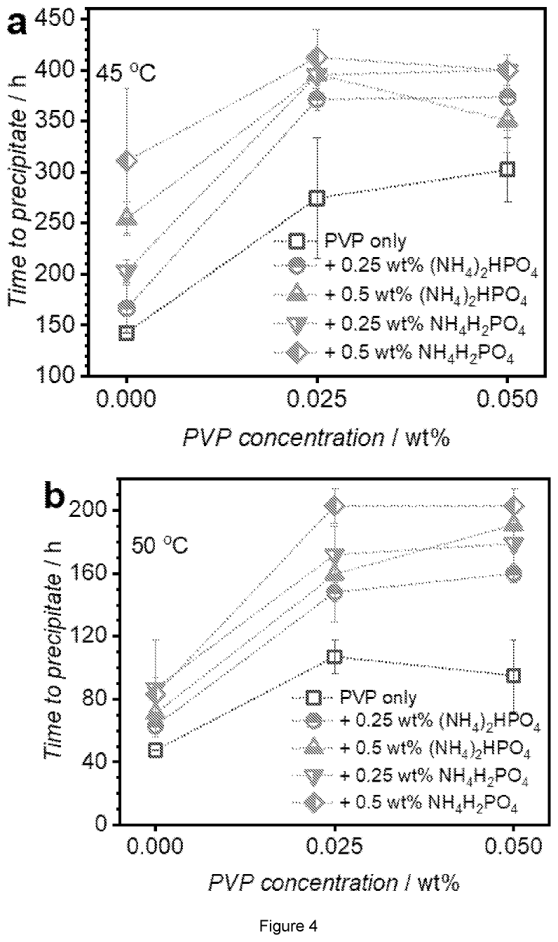

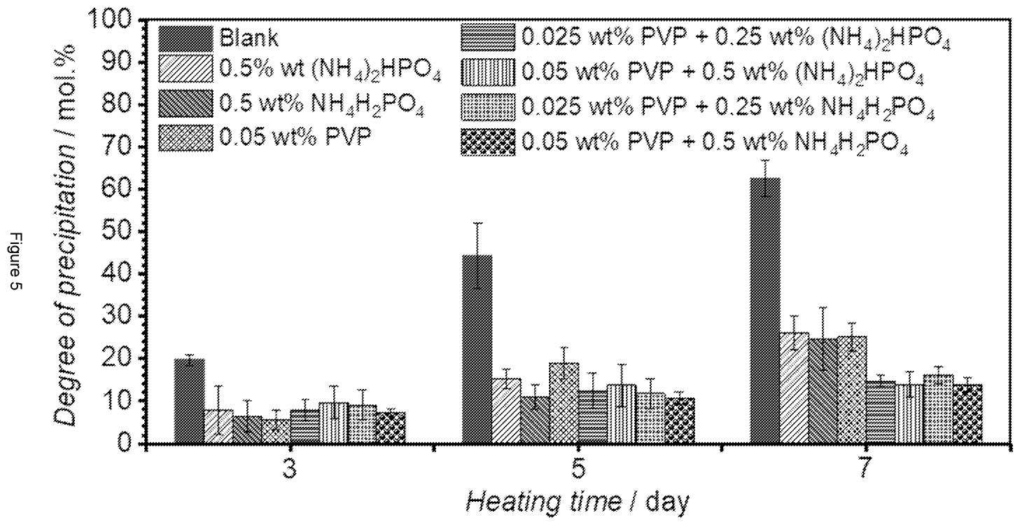

Results of the static thermal stability test are shown in FIG. 4 and Tables 1 and 2 below. The charts on the top row show simplified results, including those for PVP only (square), PVP with 0.5 wt % (NH₄)₂HPO₄ (circle), and PVP with 0.5 wt % NH₄H₂PO₄ (triangle). Full results are shown in the bottom row. The left column shows results at 45° C., while the right column shows results at 50° C.

The results show the outstanding performance obtained by using both a deprotonation inhibitor for [VO₂(H₂O)₃]⁺; and a V₂O₅ precipitation inhibitor in the stabilization of positive vanadium electrolytes at high temperatures. The use of the combined additives demonstrate much better thermal stabilizing ability in comparison with corresponding mono additives at both 45 and 50° C.

Specifically, at 45° C., the time to precipitate of the blank vanadium electrolyte is about 142.5±0.5 h. This increases to about 166.5±23.5, 203±11, 274.5±59.5 h with the addition of single components of 0.25 wt. % (NH₄)₂HPO₄, 0.25 wt. % NH₄H₂PO₄, or 0.025 wt. % PVP, respectively.

However, the dual addition of 0.025 wt. % PVP+0.25 wt. % (NH₄)₂HPO₄ (A1) or 0.025 wt. % PVP+0.25 wt. % NH₄H₂PO₄ (B1) increased the thermal stability to 371.5±10.5 and 395.5±10.5 h, respectively. In other words, addition of 0.025 wt. % PVP in the combined additives, increased the time to onset of precipitation by 123.1% as compared to just 0.25 wt. % (NH₄)₂HPO₄, or by 94.8% when compared to just 0.25 wt. % NH₄H₂PO₄.

At 50° C., we also observed the excellent performance of dual additives against the mono additives. The time to precipitate of blank electrolyte can be prolonged from 47.5±0.5 h up to about 148±6 and 172±18 h by adding A1 and B1 additives, respectively. These values are much higher than for single additives alone. As for the test at 45° C., increasing the amount of each component in such combined additives also does not significantly enhance their thermal stabilizing effectivity for the vanadium electrolyte at 50° C.

TABLE 1
Changes in precipitation time at 45° C.

| | Precipitation | Percentage Stability |
|---|---|---|
| | Time at | Increase at 45° C. |
| Stabilising Additive | 45° C. (h) | vs. no additive (%) |
| None | 142.5 | — |
| 0.25 wt. % (NH₄)₂HPO₄ | 166.5 | 16.8 |
| 0.25 wt. % NH₄H₂PO₄ | 203 | 42.5 |
| 0.025 wt. % PVP | 274.5 | 92.6 |
| 0.025 wt. % PVP + 0.25 wt. % | 371.5 | 160.7 |
| (NH₄)₂HPO₄ | | |
| 0.025 wt. % PVP + 0.25 wt. % | 395.5 | 177.5 |
| NH₄H₂PO₄ | | |

TABLE 2
Changes in precipitation time at 50° C.

| | Precipitation | Percentage Stability |
|---|---|---|
| | Time at | Increase at 50° C. |
| Stabilising Additive | 50° C. (h) | vs. no additive (%) |
| None | 45.5 | — |
| 0.25 wt. % (NH₄)₂HPO₄ | 63 | 38.5 |
| 0.25 wt. % NH₄H₂PO₄ | 87 | 91.2 |
| 0.025 wt. % PVP | 107 | 135.2 |
| 0.025 wt. % PVP + 0.25 wt. % | 148 | 225.3 |
| (NH₄)₂HPO₄ (A1) | | |
| 0.025 wt. % PVP + 0.25 wt. % | 172 | 278.0 |
| NH₄H₂PO₄ (B1) | | |

It is clear from the above results at both 45 and 50° C. that the stability increases for two additive systems are far beyond what could be achieved by doubling the concentration of the individual additives alone. It is also clear that the percentage stability increase provided by using both a deprotonation inhibitor for [VO₂(H₂O)₃]⁺ and a V₂O₅ precipitation inhibitor is far greater than the sum of the effects provided by using either a deprotonation inhibitor for [VO₂(H₂O)₃]⁺ or a V₂O₅ precipitation inhibitor alone. In other words, it is clear that the use of both a deprotonation inhibitor for [VO₂(H₂O)₃]⁺ and a V₂O₅ precipitation inhibitor results in an unexpectedly beneficial synergistic effect.

### Example 2: Precipitation Analysis

### Methods

A sample of 2 mL of the electrolyte solution having 90% state of charge (SOC) was heated at 50° C., and the precipitate nuclei in the tested solution were analyzed a laser particle size analyzer (Fritsch, Analysette 22 Compact). To analyze the precipitation rate, the tested solution (2 mL, 90% SOC) was heated at 50° C. for 3, 5 and 7 days. The resulting precipitate after each heating period was filtered and dried in air at room temperature for 24 h. Assuming that V₂O₅ is the sole product, the degree of precipitation was estimated with respect to the initial molar number of V(V).

To investigate the precipitate composition, the electrolyte samples (5 mL, 90% SOC) were also heated at 50° C. for 10 days and the precipitates collected by filtration and air-dried at 60° C. for over 24 h. X-ray diffraction (XRD) was conducted by a Shimadzu X-ray Diffractometer (Shimadzu XRD-6000, with the λ_{Cu-Kα}=0.15418 nm).

### Results

The combined additives also reduce the amount of vanadium precipitates over various heating times as compared to the blank electrolyte.

FIG. 5 indicates the degree of precipitation for different vanadium electrolyte samples. After 3-, 5- and 7-day heating at 50° C., around 19.7, 44.3 and 62.6 mol % of V(V), respectively, in the blank vanadium electrolyte solution has been precipitated. While with the use of 0.5 wt. % of NH₄H₂PO₄, this value is only about 6.4, 10.9 and 24.7 mol %, for 0.5 wt. % of (NH₄)₂HPO₄ is 7.9, 15.2 and 26.2 mol %, and for 0.05 wt. % of PVP is 5.5, 18.9 and 25.1 mol %, correspondingly. For the combined additives, the precipitation rate in 3, 5 and 7 days heating is only about 9.1, 11.7 and 16.1 mol % for the addition of A1 additive, subsequently. Also, in the case of B1 additive, this value is estimated to be around 7.8, 12.5 and 14.7% mol. Similar to the time to precipitate, increasing amount of each components in combined additive does not give remarkable effect in reducing precipitation rate of positive vanadium electrolyte.

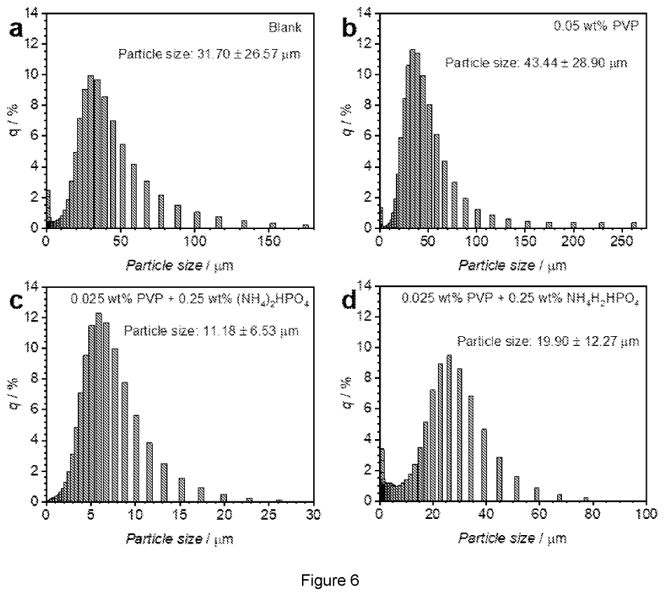

In addition to reducing the rate of precipitation, combined additives also significantly minimize the particle size of V₂O₅ precipitate (FIG. 6). The results show that after continuously heating at 50° C. for 5 days, in the blank additive-free vanadium electrolyte, the precipitate size was measured at 31.7±26.6 μm, with a wide range of particle size distribution, implying the non-uniformity of the precipitate particle under these conditions. With PVP additive, the average particle size of precipitate was larger, at about 43.4±28.9 μm, which may be due to the local condensation of precipitate nuclei under the high viscous matrix of PVP. The combined additives, again, demonstrated the most excellent effect, which produced smaller precipitates, about 19.9±12.3 and 11.2±6.5 μm for the addition of B1 and A1 additives, respectively. These results indicate the efficacy of as-studied combined additives in the restriction of the growth of precipitate at high temperatures and long heating time.

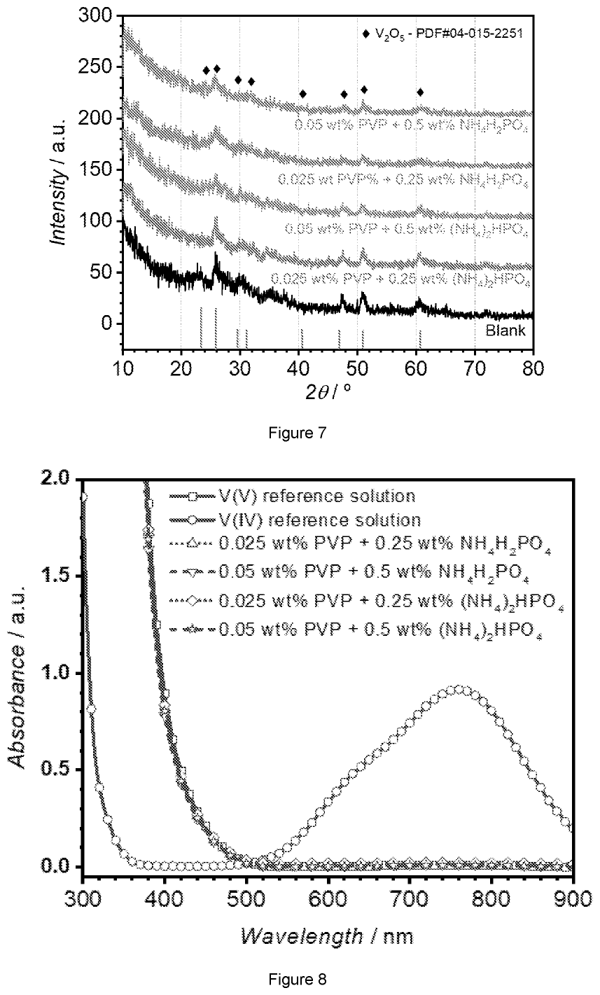

The combined additives were also examined the possibility to form any solid bi-product with the positive vanadium electrolyte. FIG. 7 shows that the precipitate compound detected was solely V₂O₅, with the major diffraction peaks at 22.5, 26.5, 32, 47, 52°, corresponding to the (001), (110), (301), (600) and (221) planes, respectively.

### Example 3: Oxidation Stage Analysis

### Methods

The effect of additives on the oxidation stage of the positive vanadium electrolyte was investigated by the Ultraviolet-visible (UV-Vis) spectra, which were recorded by a Carry Series UV-Vis-NIR Spectrophotometer with a 10 mm path-length quartz cell.

In the valence stage change experiment, 1 mL solution of 1.6 M V(V) in 4 M total SO₄²⁻ solution (100% SOC) was prepared with the addition of tested additives. To achieve a complete dissolution, all samples were sonicated for 1 h and kept for 5 days at room temperature before performing UV-vis measurements. A solution of 4 M H₂SO₄ was used as the reference solution. In practice, an aliquot of 100 μL of sample was diluted in 3 mL with reference solution to practically eliminate interference from complexes of V(IV) and V(V).

### Results

The UV-vis measurement was conducted for the combined inorganic-organic additives to affirm its stability in strong oxidative medium of V(V) electrolyte. The result showed in FIG. 8 demonstrates that the combined additives also do not change the oxidation state of V(V), implying its chemical stability in the positive vanadium electrolyte. The line for the tests performed using the various additives are essentially superimposed onto the line for V(V) reference solution, while the line for V(IV) reference solution is markedly different.

### Example 4: Electrochemical Characterization

### Methods

Cyclic voltammetry (CV) and electrochemical impedance spectroscopy in this work was performed using a BioLogic SP-150 potentiostat A three-electrode electrochemical cell with a reference electrode (Hg/Hg₂SO₄), a working electrode (glassy carbon electrode (GCE)) and a counter electrode (Pt) was used for both CV and EIS test. All measurements were done under Argon saturated condition of the electrolyte.

### Results

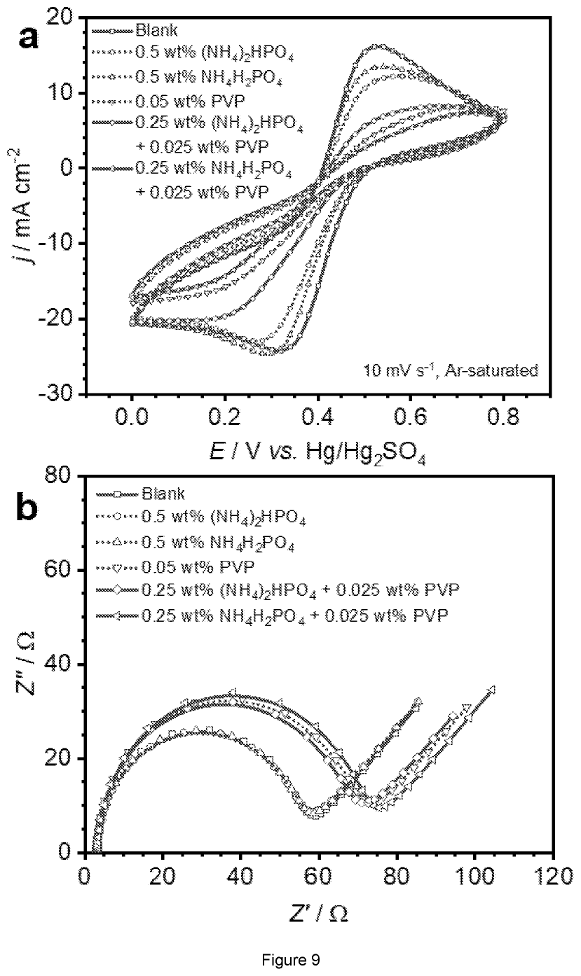

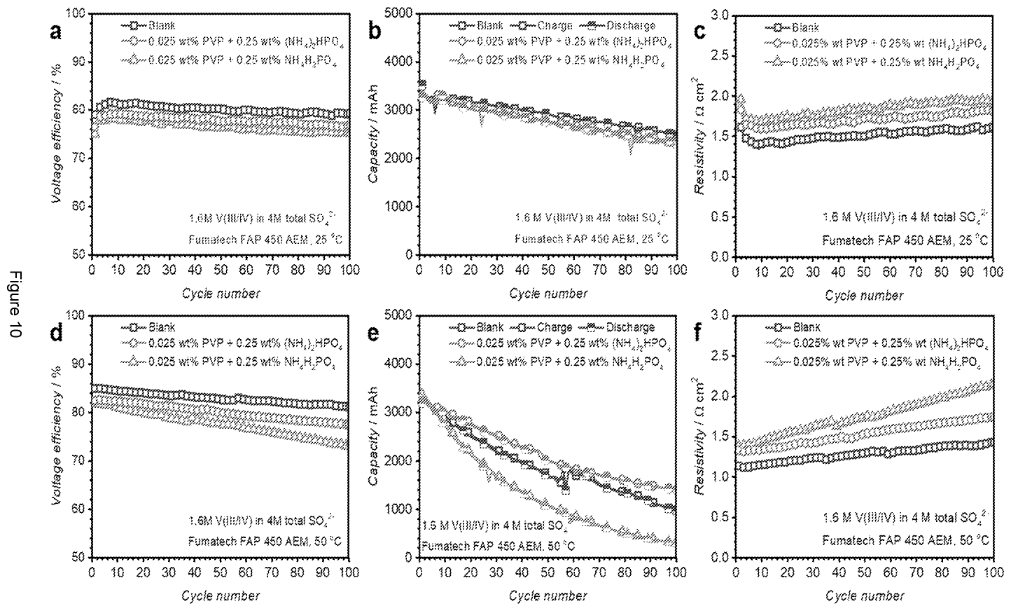

Results are shown in FIG. 9. The cyclic voltammograms of blank vanadium electrolyte are mostly unchanged with the addition of 0.5 wt. % of (NH₄)₂HPO₄ and NH₄H₂PO₄, but obviously deformed with the presence of PVP and combined additives (FIG. 9a). The detailed redox kinetic performance extracted from different cyclic voltammograms is shown in Table 3. In which, the peak potential separation ΔEₚ represents the kinetics of V(IV)/V(V) redox reaction, and the peak current ratio (the ratio between oxidation peak current and reduction peak current), Iₚₐ/I_{pc}, denotes the reversibility of V(IV)/V(V) redox reaction. In detail, the ΔEₚ of vanadium electrolyte containing 0.25 wt % of (NH₄)₂HPO₄ and NH₄H₂PO₄ is recorded to be about 0.31±0.01 and 0.22±0.03 V, respectively, mostly similar to the value of 0.24±0.02 V for the blank electrolyte. The Iₚₐ/I_{pc} value of the additive-free electrolyte is also slightly reduced from 0.65±0.01 to about 0.53±0.001 and 0.64±0.10 with the addition of 0.25 wt. % of (NH₄)₂HPO₄ and NH₄H₂PO₄, subsequently. However, with the presence of 0.025 wt. % PVP, ΔEₚ of vanadium electrolyte increases to rise 0.55±0.004 V and the Iₚₐ/I_{pc} ratio dropped to 0.51±0.004. Due to the presence of PVP, electrolyte samples containing combined additives also indicate a large drop in the redox kinetics. With the A1 and B1 additive, the ΔEₚ of vanadium electrolyte is recorded to be about 0.47±0.02 and 0.58±0.01 V; while the Iₚₐ/I_{pc} value is about 0.38±0.04 and 0.46±0.02, respectively. These results imply that PVP may partially adsorb onto and occlude the surface of glass carbon electrode (GCE) during electrochemical measurement, resulting in the observed decrease in vanadium redox kinetics. This effect is also apparent for the combined additives containing PVP. Nevertheless, the V(IV)/V(V) redox reaction still can easily take place on GCE, and the influence of PVP can be minimize when the electrolyte is employed in porous graphite electrode with much higher active surface area. Importantly, there is no other redox peaks appeared in the cyclic voltammograms of the electrolyte containing combined additives, implying their stability under electrochemical condition of vanadium electrolyte.

The Nyquist plot obtained from electrochemical impedance spectroscopy (EIS) measurement of the positive vanadium electrolyte containing different thermal stable additives is also showed in FIG. 9b. The detailed EIS parameters are listed in the Table 3, in which, the R₁ composes of solution resistance, electrode resistance and contact resistance of the electrolyte; Cd, refers to the double layer capacitance; and R₂ represents the charge transfer resistance of the active species and electrode. Interestingly, the series resistance R₁ of the blank electrolyte (3.28±0.04Ω) is mostly unchanged with the addition of all tested additives; while the charge transfer resistance R₂ and C_{dl} are only affected by the presence of PVP and combined additives (Table 3). The C_{dl} value of electrolyte containing PVP was surprisingly higher than that of electrolyte without, by about 10 ρF cm⁻². Adsorption of PVP would be expected to decrease the observed capacitance. The R₂ values further confirm the slightly detrimental impact of PVP on the kinetics of V(IV)/V(V) redox reaction as observed in cyclic voltammograms. However, these effects may become minor when using higher surface-area electrodes.

TABLE 3
Electrochemical parameters of positive vanadium electrolyte
in the presence of combined inorganic-organic additives.

| | | | EIS | | |
|---|---|---|---|---|---|
| Parameter | CV | | | | C_{dl}/μF |
| Vanadium electrolyte | ΔE_{P} (V) | Iₚₐ/I_{pc} | R₁/Ω | R₂/Ω | cm⁻² |
| Blank | 0.24 ± | 0.65 ± | 3.28 ± | 52.23 ± | 25.4 ± |
| | 0.02 | 0.01 | 0.04 | 1.47 | 3.5 |
| 0.25 wt. % (NH₄)₂HPO₄ | 0.31 ± | 0.53 ± | 3.30 ± | 52.28 ± | 26.7 ± |
| | 0.01 | 0.001 | 0.03 | 2.04 | 0.5 |
| 0.25 wt. % NH₄H₂PO₄ | 0.22 ± | 0.64 ± | 3.14 ± | 52.91 ± | 24.3± |
| | 0.03 | 0.10 | 0.002 | 2.23 | 1.4 |
| 0.025 wt. % PVP | 0.55 ± | 0.51 ± | 3.29 ± | 65.68 ± | 34.4± |
| | 0.004 | 0.004 | 0.01 | 1.46 | 1.1 |
| 0.025 wt. % PVP + | 0.47 ± | 0.38 ± | 3.09 ± | 60.67 ± | 36.2 ± |
| 0.25 wt. % | 0.02 | 0.04 | 0.03 | 2.01 | 0.4 |
| (NH₄)₂HPO₄ | | | | | |
| 0.025 wt. % PVP + | 0.58 ± | 0.46 ± | 3.39 ± | 68.39 ± | 35.8 ± |
| 0.25 wt. % | 0.01 | 0.02 | 0.01 | 1.68 | 1.0 |
| NH₄H₂PO₄ | | | | | |

### Example 5: Cell Cycling Test

### Methods

A single cell with 20 cm² active area was used to perform the cycling test with the variation of electrolyte temperature. The main component of the cell includes PVC flow frame, expended graphite bipolar plate (TF 6, SGL Carbon Group), graphite felt porous electrode (GFD 4.6 EA, SGL Carbon Group, heat treated at 600° C. for 5 h), and ion exchange membrane (Fumatech FAP 450 AEM and Nafion 117 CEM). The cell was charged and discharged with a current density of 100 mA·cm⁻² and within the potential window of 0.9-1.65 V. An amount of 100 mL vanadium electrolyte was pumped through the cell by a peristaltic pump with a flow-rate 50 mL/min. The charged/discharged cycle was controlled by a NEWARE battery testing machine.

The morphology of the graphite felt electrode after cell cycling was observed by a field emission scanning electron microscopy (FESEM, JEOL 7600F). The elemental composition of the electrode was characterized by microanalysis using an INCA EDS detector integrated with said FESEM equipment.

### Results

The cell cycling with 20 cm² single cell indicates that the voltage efficiency (VE) of the electrolyte compositions of the invention are almost unchanged as compared to original electrolyte at both 25 and 50° C.

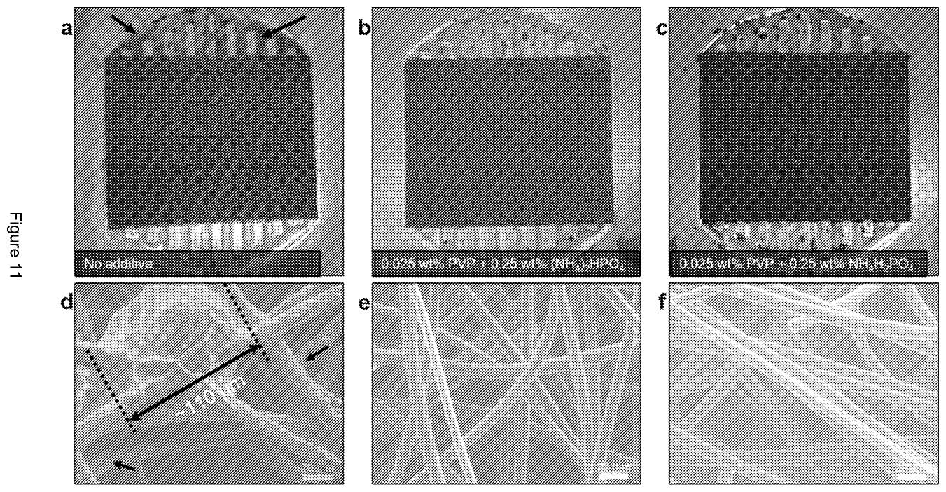

FIG. 10 presents the cycling performance with different electrolyte compositions at 25 and 50° C. of the cell using Fumatech FAP 450 anion exchange membrane (AEM). The cell structure and components is set out in FIG. 3. It was seen that at room temperature, the presence of combined additives in the pristine vanadium electrolyte causes a slight decrease of voltage efficiency (FIG. 10a). In detail, the voltage efficiency of the cell drops from about 80.2% for the blank electrolyte to about 77.9 and 76.5% for addition of A1 and B1 additives, respectively. The self-discharge current density of the cell with the addition of combined additives remain unchanged. The cell capacity drop, which mainly due to the electrolyte crossover, indicates the better performance of electrolyte containing combined additives, with the value of about 9.2 and 9.9 mAh/cycle for A1 and B1, respectively, as compared to the value of 10.5 mAh/cycle for blank electrolyte. We also noticed that when using Fumatech FAP 450 AEM, the electrolyte is diffused from the positive side to the negative side, which may be due to the interaction of positive vanadium species with the membrane. Similar to the electrochemical characterization, the cell resistivity is slightly increased when adding two additive systems into the blank electrolyte. At 50° C., only the electrolyte containing A1 additive demonstrates better long-term performance as compared to the original electrolyte (FIG. 10d-f). The voltage efficiency at 50° C. of the cell using this additive is measured to be about 80%, which is relatively similar to the value of 82.9% of the blank electrolyte; while the electrolyte containing B1 additive only achieves the voltage efficiency of about 77.4%. Additionally, the addition of this combined additive into electrolyte also resulted in the highest value of capacity drop, about 29.8 mAh/cycle, while the original electrolyte showed the number of about 22.7, and the A1 additive indicated the lowest value of 18 mAh/cycle. This suggests that the ion diffusion across the Fumatech FAP 450 AEM in the electrolyte containing B1 additive is faster than the pristine electrolyte at high temperatures. The cell resistivity of the pristine electrolyte at 50° C. indicates the value of about 1.29 Ωcm², which is lower than at 25° C. (1.51 Ωcm²) due to the reduction of Ohmic loss. When adding the combined additives, this value also slightly increases.

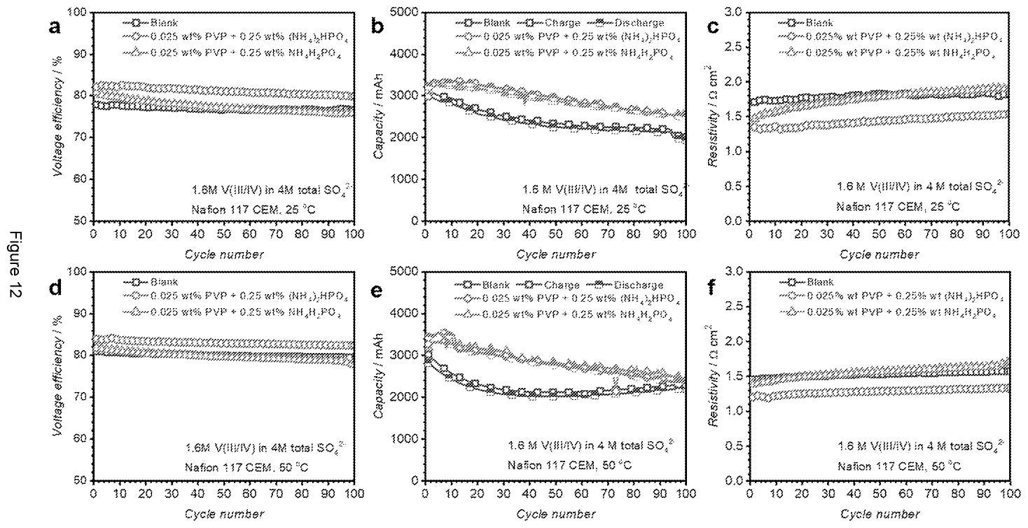

A further benefit of the combined additive is shown in FIG. 11, which shows the view of positive flow-frame and electrode after 100 charge/discharge cycles at 50° C. When using blank, additive-free electrolyte we observed a massive formation of orange precipitate in the flow channel and graphite felt electrode (FIG. 11a) and also in the positive electrolyte tank of the cell. The color alone identifies the deposits as V₂O₅, rather than dried electrolyte. With the addition of combined additives, no precipitate was observed after 100 cycles at 50° C., in either the flow frame (FIG. 11b,c) or in the electrolyte tank. Scanning electron microscopy (SEM) revealed that the precipitate dearly covers the fibers of the graphite felt electrode (FIG. 11d).

Energy Dispersive X-ray (EDX) analysis confirmed the presence of V, S and O in the precipitate, which can be assigned to the V₂O₅ with some associated sulfuric acid/sulfates. The movement of electrolyte through FAP 450 AEM may facilitate this precipitation, as the electrolyte was transferred from the positive to the negative side, therefore the positive electrolyte would have reached a higher SOC faster, leading to the faster precipitation. However, by using combined additives during cycling test, there was no obvious change on the morphology of the graphite felt (FIG. 11e,f) as compared to the original one (FIG. 11g). The EDX signal of vanadium is also negligible when scanning the surface of graphite felt electrodes after cycling test using combined additives.

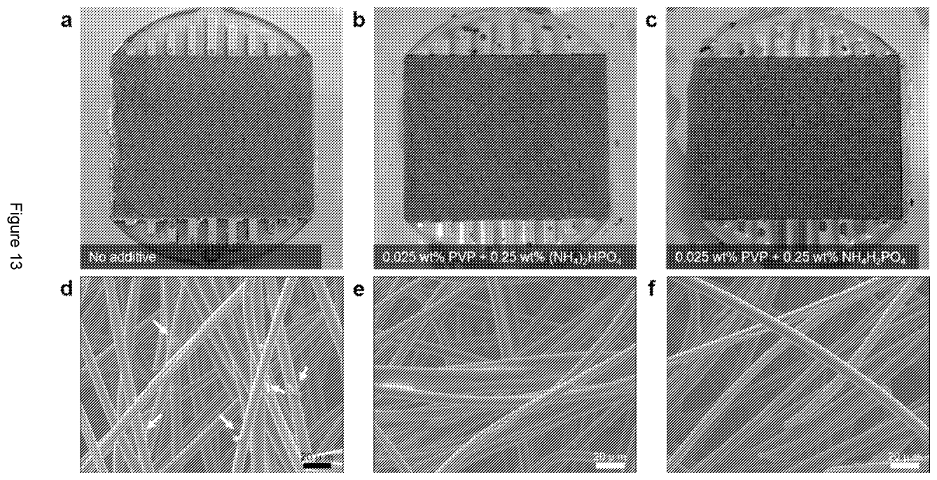

Similar tests were also performed using a cell assembled with Nafion 117 CEM. Other cell components and testing parameters were kept the same as the cell using Fumatech FAP 450 AEM. FIG. 12a-c show the cell cycling performance at room temperature for the blank and additive-added electrolyte. It is found that the cell voltage efficiency using Nafion 117 CEM is slightly lower than that of Fumatech FAP 450 AEM, about 77% compared to 80.2%. Interestingly, opposite to the cell assembled with Fumatech FAP 450 AEM, the voltage efficiency increases with the addition of combined additives into the electrolyte, with the value of 81.2 and 77.4% for A1 and B1 additives, respectively. In addition, the self-discharge current density of the cell using pristine electrolyte dramatically declined with the presence of combined additives, from 1.9 mA cm⁻² down to 0.22 and 0.2 mA cm⁻² for A1 and B1 additives, respectively. The rate of change of discharge capacity with cycle number is lower in the electrolytes with additives than the blank electrolyte, about 6.06 and 5.97 mAh/cycle as compared to the value of 11.04 mAh/cycle, implying the lower electrolyte permeation through the membrane (FIG. 12b). It should be also noted that in the case of using Nafion 117 CEM, the electrolyte crossover is found to be from negative to positive to negative side of the electrolyte tank with much lower degree of electrolyte imbalance, which is in reverse to the cell assembled with Fumatech FAP 450. Furthermore, the cell resistivity at 25° C. is measured to be about 1.8 Ωcm² for the cell operated with pristine vanadium electrolyte, and surprisingly reduced to 1.43 and 1.76 Ωcm², correspondingly, by the addition of A1 and B1 additives (FIG. 12c).

At 50° C., the cell cycling performance is also significantly improved with the presence of combined additives in the electrolyte (FIG. 12d-f). The voltage efficiency of the blank electrolyte is about 80.1%, equal to the one containing B1 additive, but increases to 83% with the presence of A1 additive (FIG. 12d). The self-discharge current density significantly dropped from the value of 2.5 mA cm⁻² to 0.4 and 0.5 mA cm⁻² with the addition A1 and B1 additives. The drop of cell capacity, obviously, is much faster for the blank electrolyte at 50° C. as compared to 25° C. But with the addition of combined additives, this dropping rate can be significantly reduced (FIG. 12e). The cell resistivity using the electrolyte containing A1 is also lower than the blank electrolyte, about 1.3 as compared to 1.5 Ωcm².

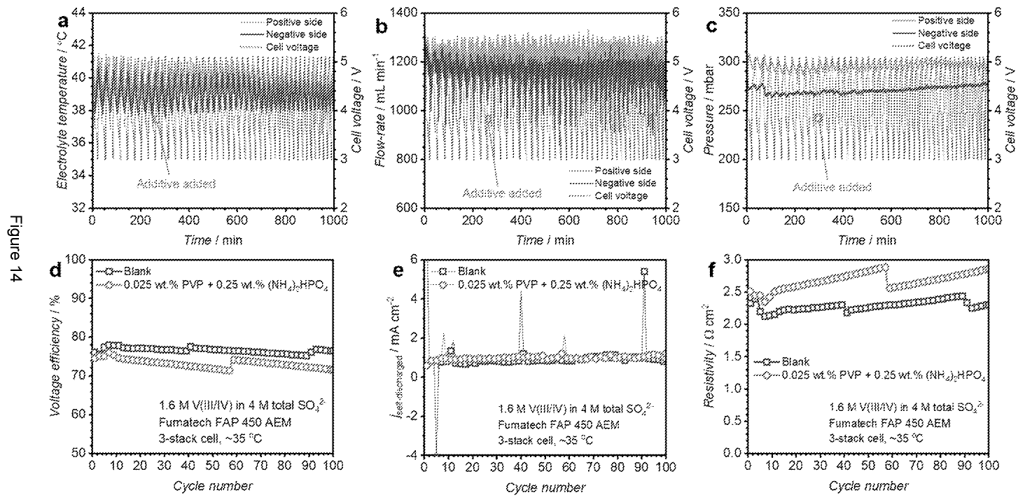

After cycling test, the possible formation of V₂O₅ precipitate in the flow-frame and electrode was also examined. There is no obvious presence of V₂O₅ precipitate as in the case of the cell assembled with Fumatech FAP 450 AEM, probably due to the crossover of negative electrolyte species that can dissolve the precipitate. Despite the lack of macroscopic deposits, it was possible to detect the formation of several V₂O₅ precipitates on the surface of the felt by SEM after cycling at 50° C. (FIG. 13d). With the presence of combined additives in the electrolyte, there is no precipitate formed in the flow-frame as well as graphite felt electrode (FIG. 13).

The different behaviors of combined additive in the ceiling cycling using different ion exchange membranes is surprising, particularly for Nafion 117 CEM. In contrast to the results in static condition, the cell performance with the electrolyte containing dual-state additives is significantly improved. The most suitable explanation is that PVP in dual-state additives may form a very thin in situ anion-exchange layer on the Nafion membrane, which would then dramatically reduce cross-over. It should be noted that PVP-based membrane was found to highly improve the VRFB performance. In the case of FAP 450 AEM, as PVP molecules will adopt a positive charge in acidic solution, it cannot be absorbed on the membrane surface to improve the cell performance. Eventually, FAP 450 AEM may interact strongly with phosphate ions, resulting to a decrease in cell activity, since it was found to vigorously interact with positive electrolyte species in our previous study.

Overall, the formation of solid V₂O₅ precipitate during cell cycling can obviously block the channel of the flow-frame as well as the surface of porous electrode. This will become a big problem in a large scale VRFB system, as the precipitate may stuck not only in the flow-frame of the cell but also in the complicated pump line system, and resulting in dangerous failure. Therefore, the advantageous excellent thermal stabilizing performance of novel combined additives for vanadium electrolyte will be highly essential in safely maintaining the system operation. The electrolyte crossover and capacity fading due to the addition of combined additives can be minimized with various electrolyte rebalancing approaches in larger scale VRFB.

### Example 6: Cycling Tests for 3-Stack Cell

The A1 and B1 additive formulae were chosen to be further evaluated in a 3-stack VRFB system.

### Methods

To demonstrate the long-term performance of new thermal stable vanadium electrolyte, a large scale VRFB with 3-stacked cell was cycled using electrolyte with and without combined additives.

The 3-stack VRFB was cycled for over 200 cycles with 1.5 L of vanadium electrolyte in each tank. The electrolyte was pumped through the VRFB system using magnetic pump. The pressure sensor and thermometer were also integrated into the system to continuously measure the electrolyte flow-rate, pressure and temperature. The charged/discharged current was controlled by a NEWARE battery testing machine. The thermal stable additives were dissolved into the pristine electrolyte prior to the cycling test.

### Results

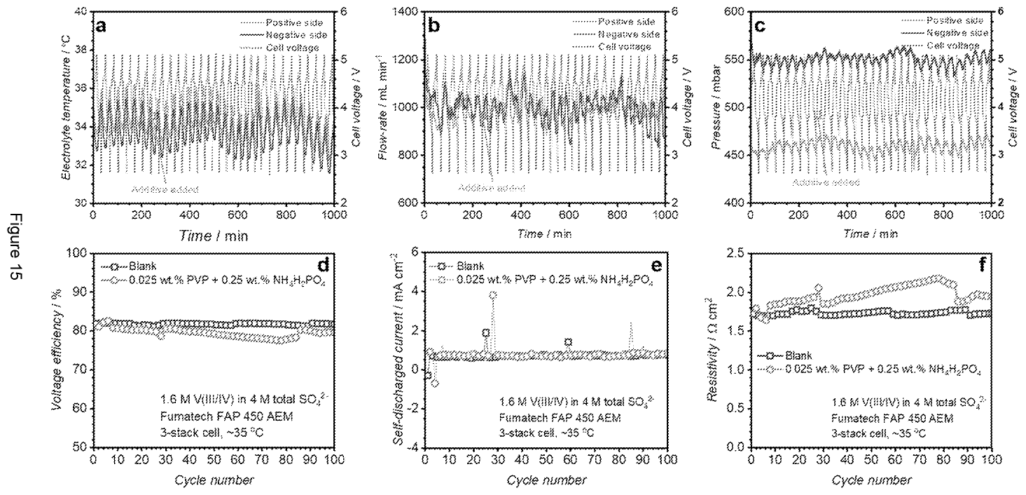

FIG. 14 presents the influence of the A1 combined additive on the physical properties and performance of 3-stack VRFB system. It was observed that the electrolyte temperature is varied from ˜38 to 40.5° C. in the negative tank, and from 39 to 42.5° C. in the positive tank. By the injection of combined additive, no increment of electrolyte temperature was found after more than 16 h of operation time (FIG. 14a). The original electrolyte flow-rate, which is measured to be about 1000-1200 mL/min for the anolyte, and about 1150-1300 mL/min for the catholyte, was also maintained stably after the addition of additive (FIG. 14b). Similarly, the pressure in the electrolyte pipe is also almost unchanged by adding the chosen additive, which is about 275 mbar at the negative line, and around 300 mbar at the positive line, respectively (FIG. 14c). These results indicate that there is no significant change in electrolyte viscosity due to the addition of these additives. The comparison between the electrochemical performance of 3-stack VRFB system using blank and additive-added electrolytes is shown in FIG. 14d-f. With addition of combined additive, the voltage efficiency of the 3-stack system is slightly lower than when using blank electrolyte, about 73.2% compared to the value of around 76.6% (FIG. 14d). The self-discharge current density remains unchanged for both electrolyte samples, about 1 mA cm⁻²; while the cell resistivity only increases from the initial value of about 2.3 Ωcm² to 2.7 Ωcm² with the presence of combined additive (FIG. 140. Overall, the cycling test using 3-stack VRFB system has demonstrated that the electrolyte containing combined additive (A1) can be operated stably in a large-scale system. Along with the excellent thermal stabilizing performance, these combined additives can be definitely employed in commercial VRFB to reduce the need of cooling systems.

For the B1 electrolyte, it was observed that the electrolyte temperature is varied from 32.5 to 35.5° C. in the negative tank, and from 33.2 to 36.2° C. in the positive tank. By the injection of combined additive, no increment of electrolyte temperature was found after more than 16 h operating time (FIG. 15a). The electrolyte flow-rate is measured to be about 892.7-1103.6 mL/min for the anolyte, and about 900.5-1070.3 mL/min for the catholyte, and was maintained stably after the addition of the combined additive. Similarly, the pressure in the electrolyte pipe is also almost unchanged by adding the combined additive, which is about 536.7-558.1 mbar at the negative side, and around 445.4-464.8 mbar at the positive side, respectively. These results indicate that there is no change of electrolyte physical property due to the addition of the additive. These results indicate that there is no significant change in electrolyte viscosity or other physical properties due to the addition of these additives.

The influence of B1 recipe on the electrochemical property of 3-stack cell performance is shown in FIG. 15d-f. The result shows that the voltage efficiency of the 3-stack cell cycling are only very slightly reduced from about 81.8% for the pristine electrolyte to about 79.6% with the addition of combined additives (FIG. 15d). These results are similar to the performance of 20 cm² single cell using the electrolyte and combined additive.

The self-discharge current density is steady even with the addition of combined additive, which is measured to be about 0.72 and 0.78 mA·cm² for pristine electrolyte and novel electrolyte. However, the cell resistivity rises from about 1.73 Ω·cm² for the blank electrolyte to around 1.96 Ω·cm² for the novel electrolyte, due to the resistance of PVP as discussed before.

### Example 7: Long Term Performance in 1 kW Cell

### Methods

Cell: 625 cm² active area; electrolyte volume: 10 L; current density: 80 mA/cm²; membrane: Fumatech FAP 450; bipolar plate: PV15; electrode: GFD 4.6 graphite felt; number of cycle: 150. Ammonium phosphate concentration: 0.25% wt; PVP concentration: 0.025% wt (both expressed as a percentage of the weight of the blank (i.e. without the additives) vanadium electrolyte).

### Results

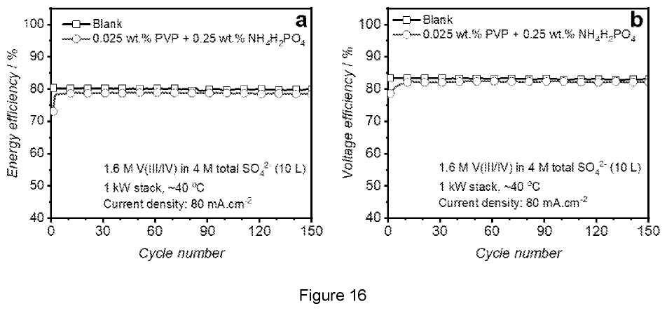

The novel combined additives (B1) also demonstrate excellent performance as compared to the pristine electrolyte when operating in 1 kW VRFB system as shown in FIG. 16. There is only a small drop in the energy efficiency and voltage efficiency due to the addition of combined inorganic-organic additives into the pristine electrolyte, from about 80.2% to 78.9% for energy efficiency, and from about 83% to 82.3% for voltage efficiency.

The excellent improvement of thermal stability indicated that as-reported additives can be used in the commercial vanadium redox flow battery. In particular, the combined additives give much higher thermal stabilizing ability for vanadium electrolyte. This is a significant factor to reduce the cost of cooling system, and therefore the overall cost of VRFB.

1. An electrolyte for a battery, the electrolyte comprising:
a solvent comprising water and sulfuric acid;
a vanadium salt;
a deprotonation inhibitor for [VO₂(H₂O)₃]⁺; and
a V₂O₅ precipitation inhibitor.

2. An electrolyte for a battery according to claim 1, wherein:
the deprotonation inhibitor for [VO₂(H₂O)₃]⁺ is an inorganic compound.

3. An electrolyte for a battery according to claim 2, wherein the inorganic compound is present in an amount of from 0.001 to 3 wt % of the combined weight of the vanadium salt and the solvent.

4. An electrolyte for a battery according to claim 3, wherein the inorganic compound is present in an amount of from 0.25 to 1 wt % of the combined weight of the vanadium salt and the solvent.

5. An electrolyte for a battery according to any one of claims 2 to 4 wherein the inorganic compound is selected from one or more of the group consisting of a phosphate salt and a non-halide ammonium containing compound.

6. An electrolyte for a battery according to claim 5, wherein the inorganic compound is selected from one or more of the group consisting of a sodium phosphate, a potassium phosphate and an ammonium phosphate.

7. An electrolyte for a battery according to claim 6, wherein the inorganic compound is one or both of NH₄H₂PO₄ and (NH₄)₂HPO₄.

8. An electrolyte for a battery according to any one of the preceding claims, wherein the V₂O₅ precipitation inhibitor is an organic compound.

9. An electrolyte for a battery according any claim 8, wherein the organic compound is present in an amount of from 0.0001 to 0.5 wt % of the combined weight of the vanadium salt and the solvent.

10. An electrolyte for a battery according to claim 9, wherein the organic compound is present in an amount from 0.025 to 0.1 wt % of the combined weight of the vanadium salt and the solvent.

11. An electrolyte for a battery according to any one of claims 8 to 10, wherein the organic compound is selected from one or more of the group consisting of a water-soluble polymer and a water-soluble gelatin compound.

12. An electrolyte for a battery according to Statement 11, wherein the organic compound is selected from one or more of the group consisting of polyvinylpyrrolidone (PVP), and a water-soluble polyalkylene glycol,
optionally wherein the organic compound is selected from one or more of polyvinylpyrrolidone and polyethylene glycol.

13. An electrolyte for a battery according to any one of the preceding claims, wherein the inorganic compound includes NH₄H₂PO₄ and the organic compound includes PVP.

14. An electrolyte for a battery according to any one of claims 2 to 12, wherein the inorganic compound includes (NH₄)₂HPO₄ and the organic compound includes PVP.

15. An electrolyte for a battery according to any one of the preceding claims, wherein the vanadium salt comprises a vanadium sulfate.

16. An electrolyte for a battery according to any one of the preceding claims, wherein the electrolyte comprises vanadium ions in a concentration of from 1.0 to 3.0 M.

17. An electrolyte for a battery according to claim 16, wherein the electrolyte comprises vanadium ions in a concentration of from 1.6 to 2M.

18. An electrolyte for a battery according to any one of the preceding claims, wherein the electrolyte comprises sulphate ions in a concentration of from 2 to 6M.

19. An electrolyte for a battery according to claim 18, wherein the electrolyte comprises sulphate ions in a concentration of from 4 to 5M.

20. An electrolyte for a battery, the electrolyte comprising:
water,
vanadium ions present in a concentration from 1.6 M to 2M;
sulfate ions present in a concentration of from 4 M to 5M; and
at least two additives, wherein
the at least two additives prevent the precipitation of more than 150 mg of V₂O₅ per 2 mL of the electrolyte following heating of the electrolyte for 7 days at 50° C.

21. An electrolyte for a battery according to claim 20, wherein the at least two additives include:
ammonium phosphate present in an amount of from 0.25 to 1 wt % of the weight of the electrolyte without the additives; and
PVP present in an amount of from 0.025 to 0.1 wt % of the weight of the electrolyte without the additives.

22. A redox flow battery comprising the electrolyte of any one of claims 1 to 21.

23. A kit of parts for stabilizing a vanadium electrolyte for use in a vanadium redox flow battery, the kit of parts comprising:
(a) a first additive composition comprising a deprotonation inhibitor for [VO₂(H₂O)₃]⁺; and
(b) a second additive composition comprising a V₂O₅ precipitation inhibitor.

24. A kit of parts for stabilizing a vanadium electrolyte for use in a vanadium redox flow battery according to claim 23, wherein the deprotonation inhibitor for [VO₂(H₂O)₃]⁺ comprises an inorganic compound.

25. A kit of parts for stabilizing a vanadium electrolyte for use in a vanadium redox flow battery according to claim 24, wherein the inorganic compound is selected from one or more of the group consisting of a phosphate salt and a non-halide ammonium containing compound.

26. A kit of parts for stabilizing a vanadium electrolyte for use in a vanadium redox flow battery according to claim 25, wherein the inorganic compound is selected from one or more of the group consisting of a sodium phosphate, a potassium phosphate and an ammonium phosphate.

27. A kit of parts for stabilizing a vanadium electrolyte for use in a vanadium redox flow battery according to claim 26, wherein the inorganic compound is one or both of NH₄H₂PO₄ and (NH₄)₂HPO₄.

28. A kit of parts for stabilizing a vanadium electrolyte for use in a vanadium redox flow battery according to any one of claims 23 to 27, wherein the V₂O₅ precipitation inhibitor comprises an organic composition.

29. A kit of parts for stabilizing a vanadium electrolyte for use in a vanadium redox flow battery according to claim 28, wherein the organic composition comprises an aqueous solution of an organic compound selected from one or more of the group consisting of a water-soluble polymer and a water-soluble gelatin.

30. A kit of parts for a stabilizing additive for addition to an electrolyte for a vanadium redox flow battery according to claim 29, wherein the organic compound is selected from one or more of the group consisting of polyvinylpyrrolidone (PVP), and a water-soluble polyalkylene glycol,
optionally wherein the organic compound is selected from one or more of polyvinylpyrrolidone and polyethylene glycol.

31. A kit of parts for a stabilizing additive for addition to an electrolyte for a vanadium redox flow battery according to claim 29 or 30, wherein the organic compound is present in a concentration of greater than or equal to 50 mg/mL in the aqueous solution.

32. A method of stabilizing a vanadium electrolyte for use in a vanadium redox flow battery,
the vanadium electrolyte comprising:
a solvent comprising water and sulfuric acid, and
a vanadium salt, the method comprising obtaining a stabilized electrolyte by:
adding a deprotonation inhibitor for [VO₂(H₂O)₃]⁺ and a V₂O₅ precipitation inhibitor to the vanadium electrolyte.

33. A method of stabilizing a vanadium electrolyte for use in a vanadium redox flow battery according to claim 32,
wherein the deprotonation inhibitor for [VO₂(H₂O)₃]⁺ is an inorganic compound

34. A method of stabilizing a vanadium electrolyte for use in a vanadium redox flow battery according to claim 33, wherein adding the deprotonation inhibitor for [VO₂(H₂O)₃]⁺ comprises dissolving the inorganic compound in the solvent.

35. A method of stabilizing a vanadium electrolyte for use in a vanadium redox flow battery according to claim 34, wherein the inorganic compound is present in an amount of 0.001-3 wt % of the vanadium electrolyte.

36. A method of stabilizing a vanadium electrolyte for use in a vanadium redox flow battery according to claim 35, wherein the inorganic compound is present in an amount of 0.25-1 wt % of the stabilized electrolyte.

37. A method of stabilizing a vanadium electrolyte for use in a vanadium redox flow battery according to any one of claims 32 to 36, wherein the inorganic compound is selected from one or more of the group consisting of a sodium phosphate, a potassium phosphate and an ammonium phosphate.

38. A method of stabilizing a vanadium electrolyte for use in a vanadium redox flow battery according to claim 37, wherein the inorganic compound is one or both of NH₄H₂PO₄ and (NH₄)₂HPO₄.

39. A method of stabilizing a vanadium electrolyte for use in a vanadium redox flow battery according to any one of claims 32 to 38, wherein the V₂O₅ precipitation inhibitor is an organic compound.

40. A method of stabilizing a vanadium electrolyte for use in a vanadium redox flow battery according to claim 39, wherein adding the V₂O₅ precipitation inhibitor comprises dissolving the organic compound in water to obtain an aqueous solution of the organic compound and adding the aqueous solution of the organic compound to the vanadium electrolyte.

41. A method of stabilizing a vanadium electrolyte for use in a vanadium redox flow battery according to claim 40, wherein the organic compound is selected from one or more of the group consisting of a water-soluble polymer and a water-soluble gelatin compound.

42. A method of stabilizing a vanadium electrolyte for use in a vanadium redox flow battery according to claim 41, wherein the organic compound is selected from one or more of the group consisting of polyvinylpyrrolidone (PVP), and a water-soluble polyalkylene glycol,
optionally wherein the organic compound is selected from one or more of polyvinylpyrrolidone and polyethylene glycol.

43. The use of a redox flow battery according to claim 22 for energy storage.
